(19) United States
(12) Patent Application Publication
(10) Pub. No.: US 2016/0092877 A1
(43) Pub. Date: Mar. 31, 2016

(54) SECURE USER AUTHENTICATION INTERFACE TECHNOLOGIES

(71) Applicant: Yen Hsiang Chew, Georgetown (MY)

(72) Inventor: Yen Hsiang Chew, Georgetown (MY)

(21) Appl. No.: 14/496,554

(22) Filed: Sep. 25, 2014

(51) Int. Cl. G06Q 20/40; G06F 3/0488; G06F 3/041

(52) U.S. Cl. CPC G06Q 20/4012; G06F 3/0412; G06F 3/0416; G06F 3/04886

(57) ABSTRACT

Technologies for secure user authentication include a computing device with a touch screen display coupled to an electronic paper display, and a security engine isolated from a host processor. To process a payment transaction, the computing device invokes the security engine to generate a random virtual keypad layout that is not accessible by the host processor. The virtual keypad layout includes virtual keypad buttons that may be randomly positioned. The security engine displays the virtual keypad layout on the electronic paper display that overlays the touch screen display. The computing device detects touch input using the touch screen and transmits the touch input to the security engine. The security engine determines keypad input based on the touch input by mapping coordinates of the touch input to virtual buttons of the virtual keypad. The security engine authorizes the transaction based on the keypad input. Other embodiments are described and claimed.

### BACKGROUND

Point of sale terminals and other computing devices complete many payment transactions every day. Additionally, general-purpose mobile computing devices such as smartphones and tablets may be used as point of sale devices. Like other computing devices, point of sale devices may be susceptible to malicious software (malware) such as computer viruses, keyloggers, screen-scrapers, or other malware. Indeed, point of sale devices may be tempting targets for identity thieves hoping to capture sensitive personal information such as passwords, security personal identification numbers (PINs) associated with payment cards, or other payment information. In particular, for point of sale devices using touch-screen input, “screen-scraping” malware may analyze frame buffer data or other graphical data of the point of sale device, together with touch input data, to identify the virtual keys pressed by the user while inputting the user's password and/or PIN.

Certain current computing devices may prevent unauthorized processes from accessing graphical data such as the contents of the video frame buffer. For example, computing devices with Intel® Identity Protection Technology with Protected Transaction Display (Intel® IPT with PTD) may display a protected PIN pad on the main display of the computing device. The protected PIN path may be displayed using a trusted I/O path of the graphics controller, such as Intel® Protected Audio/Video Path (PAVP). The trusted I/O path allows the main display of the computing device to show the PIN pad to the user, while preventing the graphical data from being accessed by unauthorized software.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for a secure user authentication interface;

FIG. 2 is a simplified block diagram of at least one embodiment of an environment that may be established by a computing device of the system of FIG. 1;

FIG. 3 is a simplified flow diagram of at least one embodiment of a method for secure user authentication that may be executed by a computing device of the system of FIGS. 1 and 2;

FIG. 4 is a schematic diagram illustrating at least one embodiment of the computing device of FIGS. 1 and 2;

FIG. 5 is a simplified block diagram of at least one embodiment of another system for a secure user authentication interface;

FIG. 6 is a simplified block diagram of at least one embodiment of various environments that may be established by the system of FIG. 5; and

FIG. 7 is a simplified flow diagram of at least one embodiment of a method for secure user authentication that may be executed by the system of FIGS. 5 and 6.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C): (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

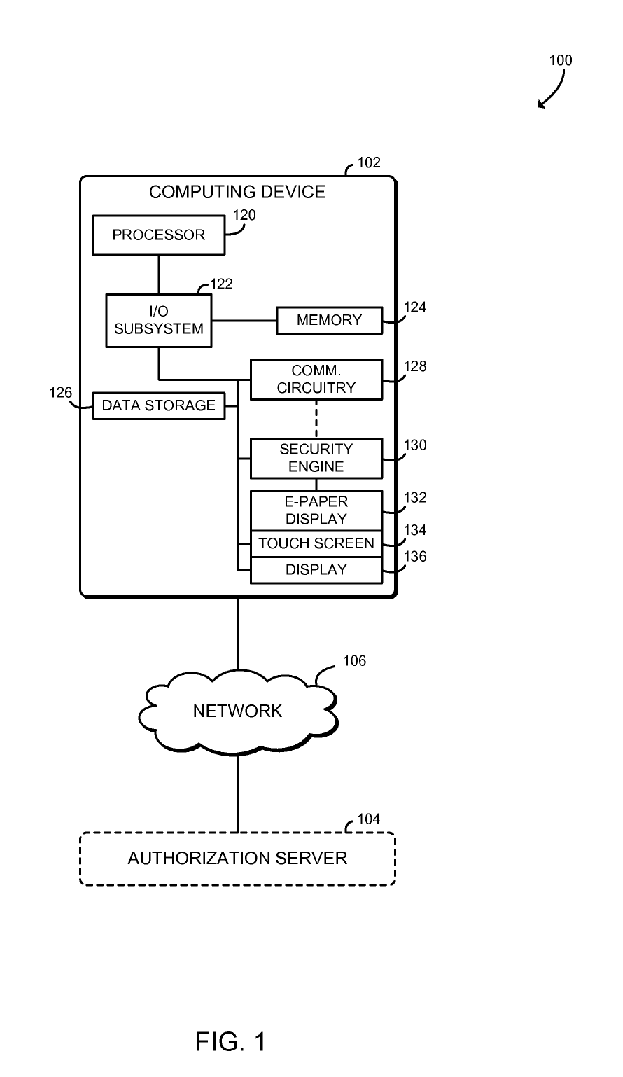

Referring now to FIG. 1, in an illustrative embodiment, a system 100 for a secure user authentication interface includes a computing device 102 and, in some embodiments, an authorization server 104 in communication over a network 106. In use, as described in more detail below, a user initiates a payment transaction on the computing device 102, for example by swiping a payment card. The computing device 102 generates and displays a virtual keypad visible on a graphical touch screen display, and the user enters a password, PIN, or other authentication information using the touch screen. The computing device 102 may authorize the transaction based on the information entered by the user, or may transmit the information to the authorization server 104 to be authorized. The computing device 102 includes a security engine that generates a random layout of the virtual keypad for each payment transaction. The security engine is isolated from a host processor the computing device 102. Rather than rendering the keypad on its primary graphical display, the computing device 102 displays the virtual keypad on a secondary display that overlays or overlaps the graphical touch screen. The secondary display is of a thin or ultra-thin design and is embodied as an electronic paper display in the illustrative embodiments described herein. The electronic paper display is controlled by the security engine and is similarly isolated from the host processor of the computing device 102. Thus, the system 100 may prevent unauthorized access to the user's password or PIN without requiring a dedicated, secure hardware keyboard or keypad. In particular, the system 100 determines and authorizes the password or PIN using the security engine rather than the host processor. Additionally, by randomizing the virtual keypad layout, the system 100 protects against malware that reconstructs passwords from touch input. Similarly, by displaying the keypad on the electronic paper display that is not accessible to the host processor, the system 100 protects against malware that analyzes the display frame buffer or other graphical display information to reconstruct passwords.

The computing device 102 may be embodied as any type of computation or computer device capable of performing the functions described herein, including, without limitation, a point-of-sale terminal, a tablet computer, a mobile computing device, a smartphone, a tablet, a computer, a desktop computer, a workstation, a laptop computer, a notebook computer, a wearable computing device, a network appliance, a web appliance, a distributed computing system, a processor-based system, and/or a consumer electronic device. As shown in FIG. 1, the computing device 102 illustratively includes a processor 120, an input/output subsystem 122, a memory 124, a data storage device 126, and communication circuitry 128. Of course, the computing device 102 may include other or additional components, such as those commonly found in a point-of-sale device (e.g., magnetic strip card readers, near field communication sensors, or various other input/output devices), in other embodiments. Additionally, in some embodiments, one or more of the illustrative components may be incorporated in, or otherwise form a portion of, another component. For example, the memory 124, or portions thereof, may be incorporated in one or more processor 120 in some embodiments.

The processor 120 may be embodied as any type of processor capable of performing the functions described herein. The processor 120 may be embodied as a single or multi-core processor(s), digital signal processor, microcontroller, or other processor or processing/controlling circuit. Similarly, the memory 124 may be embodied as any type of volatile and/or non-volatile memory or data storage capable of performing the functions described herein. In operation, the memory 124 may store various data and software used during operation of the computing device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the computing device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the computing device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication circuitry 128 of the computing device 102 may be embodied as any communication circuit, device, or collection thereof, capable of enabling communications between the computing device 102, the authorization server 104, and/or other remote devices over the network 106. The communication circuitry 128 may be configured to use any one or more communication technology (e.g., wired or wireless communications) and associated protocols (e.g., Ethernet, Bluetooth®, Wi-Fi®, WiMAX, 3G, 4G, etc.) to effect such communication.

The computing device 102 also includes a security engine 130, which may be embodied as any hardware component(s) or circuitry capable of executing code and/or accessing data that is independent and secure from other code executed by the processor 120 of the computing device 102. The security engine 130 may be embodied as a manageability engine, an out-of-band processor, a Trusted Platform Module (TPM), or other security engine device or collection of devices. In some embodiments the security engine 130 may be embodied as a converged security and manageability engine (CSME) incorporated in a system-on-a-chip (SoC) of the computing device 102. Further, in some embodiments, the security engine 130 is also capable of communicating using the communication circuitry 128 or a dedicated communication circuit independently of the state of the computing device 102 (e.g., independently of the state of the primary processor 120), also known as “out-of-band” communication.

The computing device 102 further includes an electronic paper display 132, a touch screen 134, and a display 136. In the illustrative embodiment, the display 136 is a liquid crystal display (LCD); however, the display 136 may be embodied as any type of display capable of displaying digital information such as an LCD, a light emitting diode (LED) display, a plasma display, a cathode ray tube (CRT), or other type of display device. The processor 120 may output image data for display by the display 136 and may also read image data corresponding to what is currently displayed by the display 136, for example by reading a frame buffer. The touch screen 134 may be embodied as any type of touch screen capable of generating input data in response to being touched by the user of the computing device 102. The touch screen 134 may be embodied as a resistive touch screen, a capacitive touch screen, or a camera-based touch screen. The touch screen 134 may be responsive to multiple simultaneous touch points.

The electronic paper display 132 may be embodied as an electrophoretic bistable display capable of displaying digital information. The electronic paper display 132 is coupled to or otherwise controlled by the security engine 130. The security engine 130 may output image data for display by the electronic paper display 132. The processor 120 may not output image data to the electronic paper display 132 or otherwise access the image data displayed by the electronic paper display 132. The electronic paper display 132 overlaps or otherwise visually coincides with at least part of the touch screen 134 and the display 136. For example, the electronic paper display 132 may be positioned on top of the touch screen 134, which may be positioned on top of the display 136. As another example, the touch screen 134 may be positioned on top of the electronic paper display 132, which may be positioned on top of the display 136. Thus, touch positions sensed by the touch screen 134 may coincide with locations within the electronic paper display 132. The electronic paper display 132 may be transparent when not displaying image data, allowing the contents of the display 136 to shine through the electronic paper display 132. The electronic paper display 132 may be laminated or bonded to the touch screen 134 and/or the display 136 or simply positioned on top of the touch screen 134 and/or the display 136. Although the electronic paper display 132 is illustratively shown as integral to the computing device 102, the electronic paper display 132 and associated circuitry may be separate from, but communicatively coupled to, the computing device 102 in other embodiments. In some embodiments, the electronic paper display 132 may be removable by the user. Although illustrated as an electronic paper display 132, it should be understood that in other embodiments the computing device 102 may include any type of secondary display capable of displaying digital information overlaid over the display 136 and using any suitable display technology.

The authorization server 104 is configured to provide user credential, payment information, and/or other authentication and authorization services. The authorization server 104 may be embodied as any type of server computing device, or collection of devices, capable of performing the functions described herein. As such, the authorization server 104 may be embodied as a single server computing device or a collection of servers and associated devices. For example, in some embodiments, the authorization server 104 may be embodied as a “virtual server” formed from multiple computing devices distributed across the network 106 and operating in a public or private cloud. Accordingly, although the authorization server 104 is illustrated in FIG. 1 as embodied as a single server computing device, it should be appreciated that the authorization server 104 may be embodied as multiple devices cooperating together to facilitate the functionality described below.

As discussed in more detail below, the computing device 102 and the authorization server 104 may be configured to transmit and receive data with each other and/or other devices of the system 100 over the network 106. The network 106 may be embodied as any number of various wired and/or wireless networks. For example, the network 106 may be embodied as, or otherwise include, a wired or wireless local area network (LAN), a wired or wireless wide area network (WAN), a cellular network, and/or a publicly-accessible, global network such as the Internet. As such, the network 106 may include any number of additional devices, such as additional computers, routers, and switches, to facilitate communications among the devices of the system 100.

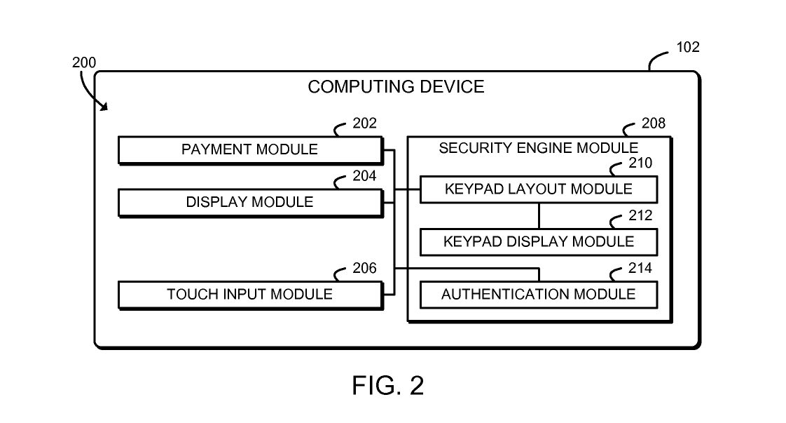

Referring now to FIG. 2, in an illustrative embodiment, the computing device 102 establishes an environment 200 during operation. The illustrative environment 200 includes a payment module 202, a display module 204, a touch input module 206, and a security engine module 208. The various modules of the environment 200 may be embodied as hardware, firmware, software, or a combination thereof. For example the various modules, logic, and other components of the environment 200 may form a portion of, or otherwise be established by, the processor 120, the security engine 130, and/or other hardware components of the computing device 102.

The payment module 202 is configured to detect payment requests initiated by the user and invoke the security engine module 208 to generate a virtual keypad layout in response to the payment requests. Payment requests may include any user action initiating a payment transaction, such as selecting a user interface command, swiping a payment card, or bringing a near-field communication payment device near the computing device 102. The payment module 202 is also configured to process the payment transaction in response to user input authentication, as further described below.

The display module 204 is configured to control the display 136. In particular, the display module 204 is configured to clear at least a part of the display 136 in response to detecting the payment request, and prior to the virtual keypad layout being displayed by the security engine module 208. The display module 204 may also display visual feedback such as a password field, OK/Cancel buttons, or other user interface controls during password entry.

The touch input module 206 is configured to detect touch input using the touch screen 134 and transmit the touch input to the security engine module 208. The touch input may be indicative of one or more user touch interactions, such as taps, swipes, presses, or other user interactions sensed by the touch screen 134. The touch input may include one or more coordinates (e.g., x- and y-coordinates) associated with each of the touch interactions. The coordinates may identify a location of the touch interaction on the touch screen 134 and, thus, also identifies a location on the display 136 and the electronic paper display 132.

The security engine module 208 is established by the security engine 130. Therefore, the executable code and other data accessed, created, and otherwise used by sub-modules of the security engine module 208 may not be accessed by unauthorized components of the computing device 102, for example unauthorized software executed by the processor 120. The security engine module 208 further includes a keypad layout module 210, a keypad display module 212, and an authentication module 214. As described above, the various sub-modules of the security engine module 208 may be embodied as hardware, firmware, software, or a combination thereof. For example the various sub-modules, logic, and other components of the security engine module 208 may form a portion of, or otherwise be established by, the security engine 130 or other hardware components of the computing device 102.

The keypad layout module 210 is configured to generate a random virtual keypad layout. The virtual keypad includes several virtual buttons that may be selected by the user to enter a password or PIN. For example, the virtual keypad may include virtual buttons for any combination of letters, numbers, symbols, or control functions (e.g., backspace, escape, return, etc.). The virtual keypad layout defines the location and/or ordering of the virtual buttons included in a virtual keypad. The virtual keypad layout may be randomized by randomly selecting the position of the virtual keypad, the position of the virtual buttons of the keypad, and/or the characters or functions associated with each virtual button. The keypad layout module 210 is also configured to determine the keypad input entered by the user based on touch input received from the touch input module 206. For example, the keypad layout module 210 may analyze coordinates of the touch input to identify the virtual keypad button at those coordinates and to determine the associated input character or control function. Because the keypad layout module 210 is established by the security engine 130, the virtual keypad layout and the keypad input may not be accessed by the processor 120 of the computing device 102.

The keypad display module 212 is configured to display the virtual keypad layout on the electronic paper display 132. As described above, the electronic paper display 132 overlays at least a part of the display 136, and the user may interact with the touch screen 134 using the virtual buttons of the virtual keypad displayed by the electronic paper display 132 as a guide. Because the keypad display module 212 is established by the security engine 130, the contents of the electronic paper display 132 may not be accessed by the processor 120 of the computing device 102.

The authentication module 214 is configured to authorize the payment transaction based on the keypad input. The authentication module 214 may be configured to perform local authentication or remote authentication using the authorization server 104. For example, the authentication module 214 may locally authenticate or otherwise verify a user password or PIN entered by the user. As another example, the authentication module 214 may encrypt the keypad input and transmit the encrypted keypad input to the authorization server 104 to be authenticated.

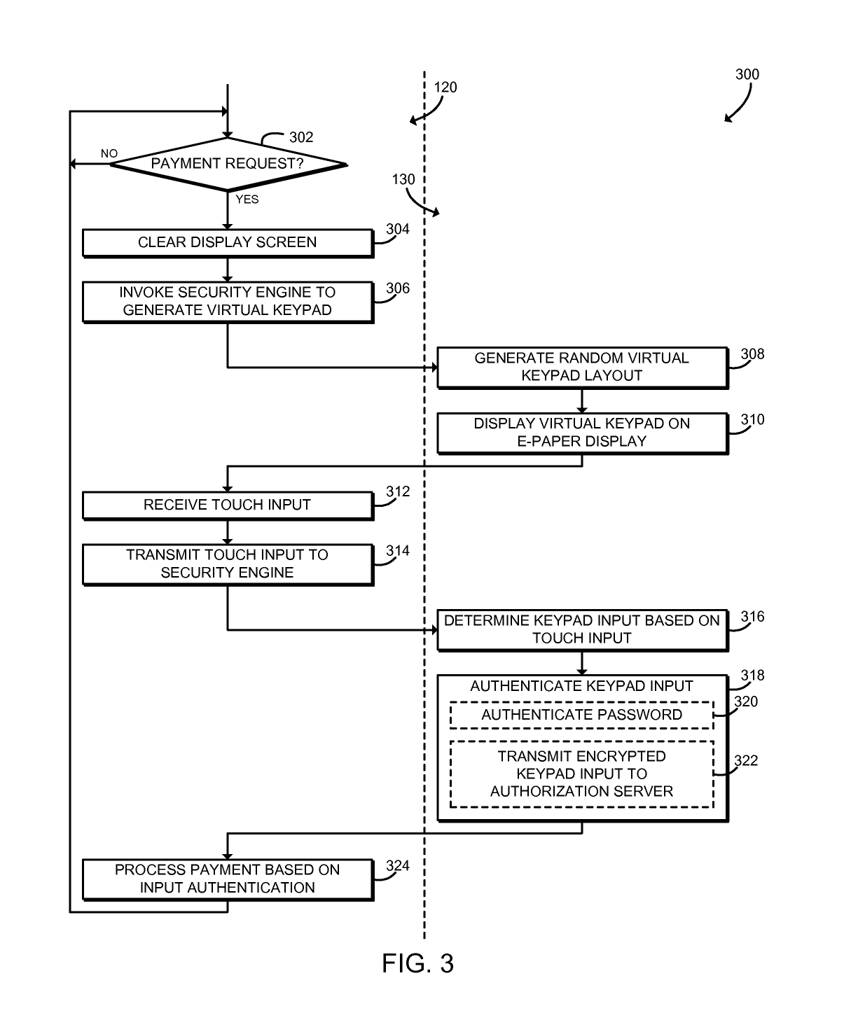

Referring now to FIG. 3, in use, the computing device 102 may execute a method 300 for secure user authentication. The method 300 begins with block 302, which is executed by the processor 120 of the computing device 102 as shown. In block 302, the computing device 102 determines whether a payment request has been received. A payment request may be initiated by a user of the computing device 102. For example, the user may swipe a payment card, place a near-field communication payment device near the computing device 102, or otherwise initiate a payment transaction. If no payment request has been received, the method 300 loops back to block 302 to continue monitoring for payment requests. If a payment request has been received, the method 300 advances to block 304.

In block 304, the computing device 102 clears a part of or all of the display 136. The computing device 102 may clear the part of the display 136 that coincides with the electronic paper display 132. Thus, graphical data displayed by the display 136 may not interfere with the electronic paper display 132. The computing device 102 may clear the display 136 by, for example, displaying a solid color such as white on part or all of the display 136. By displaying a solid color, malicious software may not gather any sensitive information from analysis of the frame buffer associated with the display 136. In some embodiments, the display 136 may display non-sensitive information on parts of the display 136 that do not conflict with the electronic paper display 132. For example, the display 136 may include instructions, a password prompt, user interface controls (e.g., OK or Cancel buttons), or other user interface features.

In block 306, the computing device 102 invokes the security engine 130 to generate a virtual keypad for secure user authentication. The computing device 102 may use any appropriate technique to invoke the security engine 130. For example, the computing device 102 may transmit information using a manageability interface such as a host embedded controller interface (HECI) bus, transmit information using a firmware mailbox, establish a network connection between the computing device 102 and the security engine 130, or use any other appropriate communication technique.

The method 300 continues with block 308, which is executed by the security engine 130 of the computing device 102. In block 308, the computing device 102 generates a random virtual keypad layout. The virtual keypad layout defines locations for virtual input buttons that will be used as a virtual keypad to collect user input. Each virtual input button may correspond with, for example, an input character such as a letter, number, symbol, or other character or may correspond with a control function such as backspace, escape, or return. The computing device 102 may use any technique to randomize the order, placement, and/or contents of the virtual input buttons. Because the virtual keypad layout is generated by the security engine 130, the virtual keypad layout is not accessible by the processor 120.

In block 310, the computing device 102 displays the virtual keypad on the electronic paper display 132. The computing device 102 may display the keypad as, for example, a collection of virtual buttons or other input controls arranged on the electronic paper display 132. Because the virtual keypad layout is displayed on the electronic paper display 132 by the security engine 130, the graphical information associated with the virtual keypad layout is not accessible by the processor 120.

The method 300 continues with block 312, which is executed by the processor 120 of the computing device 102. In block 312, the computing device 102 receives touch input from the touch screen 134. The computing device 102 may receive touch input corresponding to one or more user touch interactions, such as taps, swipes, or other similar input events. The touch input may include one or more coordinates (e.g., x- and y-coordinates in pixels) identifying the location or locations of the corresponding user touch interactions on the touch screen 134. As described above, those coordinates may correspond to parts of the display 136 that have been cleared or that otherwise do not provide any graphical information concerning the target touched by the user.

In block 314, the computing device 102 transmits the touch input to the security engine 130. The computing device 102 may transmit any information that indicates the coordinates associated with the detected touch input. The computing device 102 may use any appropriate technique to communicate the information to the security engine 130. For example, the computing device 102 may transmit information using a manageability interface such as an HECI bus, transmit information using a firmware mailbox, establish a network connection between the computing device 102 and the security engine 130, or use any other appropriate communication technique.

The method 300 continues with block 316, which is executed by the security engine 130 of the computing device 102. In block 316, the computing device 102 determines keypad input based on the touch input received from the touch screen 134. The keypad input may represent any character (e.g., a letter, number, or symbol) or control function corresponding to the virtual keypad button touched by the user. The computing device 102 may map the coordinates of the touch input to virtual buttons of the virtual keypad layout. The computing device 102 may, for example, read the coordinates associated with the touch input and identify the virtual keypad button corresponding with those coordinates. The keypad input may be stored as, for example, a character string representing the password or PIN entered by the user.

In some embodiments, the security engine 130 may transmit a response message to the primary processor 120 in response to determining the keypad input. The response message may, for example, include a code indicating that a character button was pressed. Upon receiving the response message, the computing device 102 may provide visual feedback to the user, for example by printing a placeholder character such as “*” in a password field. As another example, the response message may indicate that the user has selected an erase button, clear button, or other control function of the virtual keypad, and the computing device 102 may provide appropriate visual feedback for that control function.

In block 318, the computing device 102 authenticates the keypad input. The computing device 102 may perform any user authentication, payment authentication, or other authentication or authorization process based on the keypad input entered by the user. The security engine 130 may transmit a message to the processor 120 indicating whether the keypad input was successfully authenticated. In block 320, in some embodiments, the computing device 102 may authenticate a password. The computing device 102 may, for example, verify that the keypad input matches a user password. In block 322, in some embodiments, the computing device 102 may encrypt the keypad input and transmit the encrypted keypad input to the authorization server 104 to be authenticated.

After authenticating the keypad input, the method 300 continues in block 324, which is executed by the processor 120 of the computing device 102. In block 324, the computing device 102 processes the payment request based on the input authentication. The computing device 102 may successfully complete the requested payment transaction if the keypad input was authenticated, reject the payment transaction if the keypad input was not authenticated, or perform any other appropriate action based on the input authentication. After processing the payment request, the method 300 loops back to block 302 to monitor for additional payment requests.

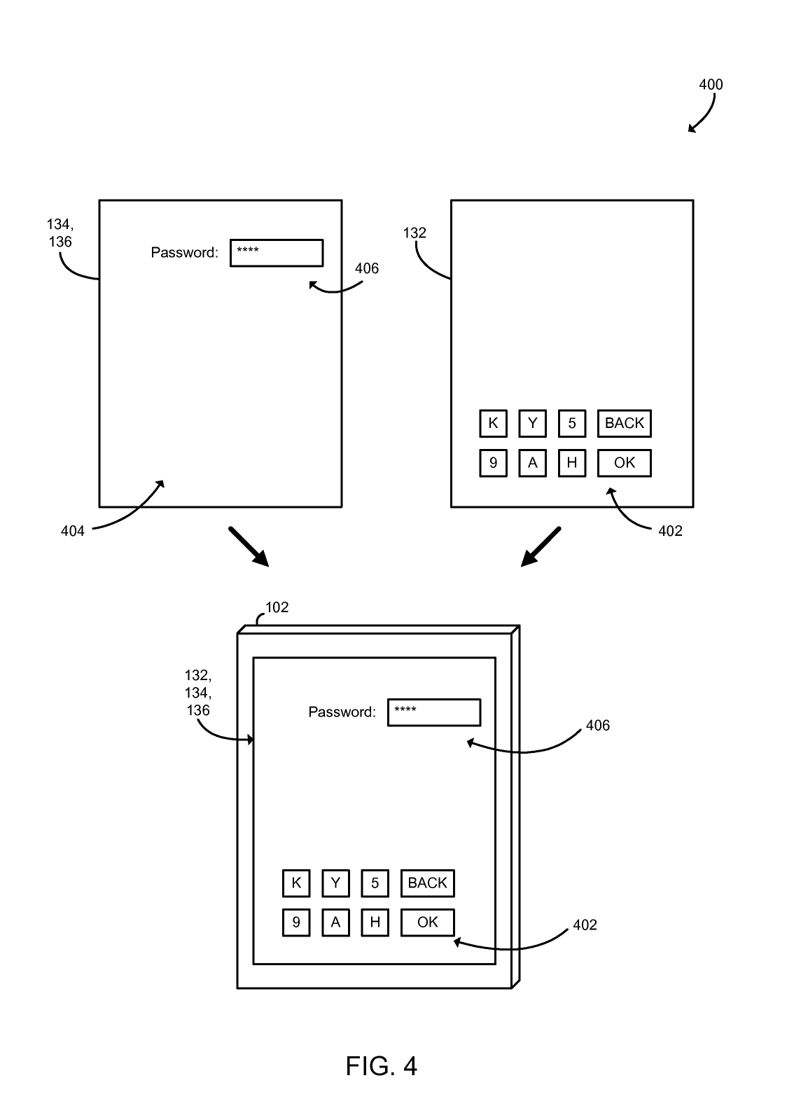

Referring now to FIG. 4, a schematic diagram 400 illustrates one embodiment of the computing device 102. The diagram 400 illustrates the electronic paper display 132 and the display 136 separately, and also illustrates the assembled computing device 102 with the electronic paper display 132 overlaying the display 136. As shown, the electronic paper display 132 displays a virtual keypad layout 402 on its lower part. As shown, the virtual keypad layout 402 includes virtual buttons corresponding to letters and numbers, and in the illustrative embodiment includes two virtual buttons corresponding to control functions (“BACK” and “OK”). The virtual buttons of the virtual keypad layout 402 are arranged in a random order. As shown, the display 136 includes a blank area 404 that corresponds to the location of the virtual keypad layout 402 on the electronic paper display 132. The display 136 also includes a password field 406 on its upper part. The virtual keypad layout 402 does not overlap or otherwise interfere with the password field 406. As shown, the password field 406 may display visual feedback (e.g., “*” characters) as the user enters a password or PIN on the virtual keypad layout 402. Of course, in some embodiments the display 136 may be completely blank, without including the password field 406.

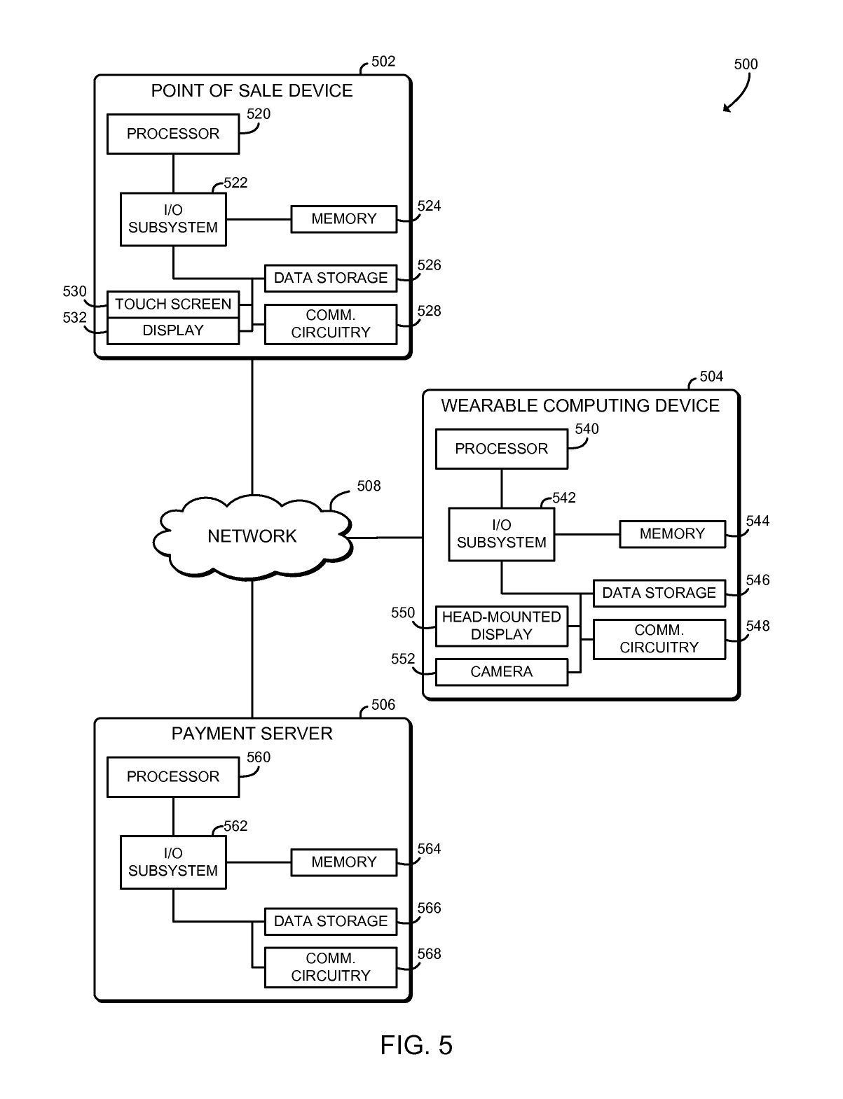

Referring now to FIG. 5, in an illustrative embodiment, a system 500 for a secure user authentication interface includes a point of sale device 502, a wearable computing device 504, and a payment server 506 in communication over a network 508. In use, as described in more detail below, a user initiates a payment transaction on the point of sale device 502, for example by swiping a payment card. The payment server 506 generates a random layout of a virtual keypad for each payment transaction, and transmits the virtual keypad layout to the wearable computing device 504. The wearable computing device 504 displays the virtual keypad as being superimposed over a graphical touch screen display of the point of sale device 502. Displaying virtual objects that appear to be superimposed on physical objects or otherwise present in the physical world is sometimes known as “augmented reality.” The user enters a password, PIN, or other authentication information using the touch screen of the point of sale device 502 while visually referencing the virtual keypad displayed by the wearable computing device 504. The point of sale device 502 transmits touch screen input to the payment server 506, which authorizes the transaction based on the touch screen input. Thus, the system 500 may prevent unauthorized access to the user's password or PIN without requiring a dedicated, secure hardware keyboard or keypad. In particular, by displaying the keypad using the wearable computing device 504 and accepting touch input using the point of sale device 502, malware that compromises one of those devices 502, 504 alone may not reconstruct the user password. Additionally, because the virtual keypad layout is randomized and the wearable computing device 504 is private to the user, the password may not be reconstructed by an over-the-shoulder eavesdropper, video camera, or other view of the display of the point of sale device 502.

The point of sale device 502 may be embodied as any type of computation or computer device capable of performing the functions described herein, including, without limitation, a point-of-sale terminal, a tablet computer, a mobile computing device, a computer, a desktop computer, a workstation, a laptop computer, a notebook computer, a wearable computing device, a network appliance, a web appliance, a distributed computing system, a processor-based system, and/or a consumer electronic device. As shown in FIG. 1, the point of sale device 502 illustratively includes a processor 520, an input/output subsystem 522, a memory 524, a data storage device 526, and communication circuitry 528. Of course, the point of sale device 502 may include other or additional components, such as those commonly found in a desktop computer (e.g., various input/output devices), in other embodiments. Additionally, in some embodiments, one or more of the illustrative components may be incorporated in, or otherwise form a portion of, another component. For example, the memory 524, or portions thereof, may be incorporated in one or more processor 520 in some embodiments.

The processor 520 may be embodied as any type of processor capable of performing the functions described herein. The processor 520 may be embodied as a single or multi-core processor(s), digital signal processor, microcontroller, or other processor or processing/controlling circuit. Similarly, the memory 524 may be embodied as any type of volatile or non-volatile memory or data storage capable of performing the functions described herein. In operation, the memory 524 may store various data and software used during operation of the point of sale device 502 such as operating systems, applications, programs, libraries, and drivers. The memory 524 is communicatively coupled to the processor 520 via the I/O subsystem 522, which may be embodied as circuitry and/or components to facilitate input/output operations with the processor 120, the memory 524, and other components of the point of sale device 502. For example, the I/O subsystem 522 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 522 may form a portion of a system-on-a-chip (SoC) and be incorporated, along with the processor 520, the memory 524, and other components of the point of sale device 502, on a single integrated circuit chip.

The data storage device 526 may be embodied as any type of device or devices configured for short-term or long-term storage of data such as, for example, memory devices and circuits, memory cards, hard disk drives, solid-state drives, or other data storage devices. The communication circuitry 528 of the point of sale device 502 may be embodied as any communication circuit, device, or collection thereof, capable of enabling communications between the point of sale device 502, the payment server 506, and/or other remote devices over the network 508. The communication circuitry 528 may be configured to use any one or more communication technology (e.g., wired or wireless communications) and associated protocols (e.g., Ethernet, Bluetooth®, Wi-Fi®, WiMAX, 3G, 4G, etc.) to effect such communication.

The point of sale device 502 further includes a touch screen 530 and a display 532. The display 532 may be embodied as any type of display capable of displaying digital information such as a liquid crystal display (LCD), a light emitting diode (LED) display, a plasma display, a cathode ray tube (CRT), or other type of display device. The touch screen 530 may be embodied as any type of touch screen capable of generating input data in response to being touched by the user of the point of sale device 502. The touch screen 530 may be embodied as a resistive touch screen, a capacitive touch screen, or a camera-based touch screen.

The wearable computing device 504 is configured to display digital content on a heads-up or other head-mounted display visible only to the user of the wearable computing device 504. The wearable computing device 504 may be embodied as any type of computation or computer device capable of performing the functions described herein, including, without limitation, smart glasses, a wearable computing device, a mobile computing device, a multiprocessor system, a distributed computing system, a processor-based system, a computer, and/or a consumer electronic device. Illustratively, the wearable computing device 504 includes a processor 540, an I/O subsystem 542, a memory 544, a data storage device 546, communication circuitry 548, and/or other components and devices commonly found in a wearable computing device or similar computing device. Those individual components of the wearable computing device 504 may be similar to the corresponding components of the point of sale device 502, the description of which is applicable to the corresponding components of the wearable computing device 504 and is not repeated herein so as not to obscure the present disclosure.

The wearable computing device 504 further includes a head-mounted display 550 and a camera 552. The head-mounted display 550 may be embodied as any type of display mountable to the user's head and capable of projecting digital visual information in the user's field of vision. In some embodiments, the head-mounted display 550 may be transparent or semitransparent and thus capable of displaying information in a portion of the user's field of vision without obscuring the rest of the user's vision. Such partial displays may be known as display overlays, or simply overlays. In some embodiments, the head-mounted display 550 may include a display source such as a liquid crystal display (LCD) or a light emitting diode (LED) array that projects display information onto a small, clear or translucent prismatic display screen positioned in front of the user's eye.

The camera 552 may be embodied as a digital camera or other digital imaging device integrated with the wearable computing device 504 or otherwise communicatively coupled thereto. The camera 552 includes an electronic image sensor, such as an active-pixel sensor (APS), e.g., a complementary metal-oxide-semiconductor (CMOS) sensor, or a charge-coupled device (CCD).

The payment server 506 is configured to provide payment authentication and authorization services. The payment server 506 may be embodied as any type of computation or computer device capable of performing the functions described herein, including, without limitation, a computer, a multiprocessor system, a server, a rack-mounted server, a blade server, a laptop computer, a notebook computer, a tablet computer, a wearable computing device, a network appliance, a web appliance, a distributed computing system, a processor-based system, and/or a consumer electronic device. Illustratively, the payment server 506 includes a processor 560, an I/O subsystem 562, a memory 564, a data storage device 566, communication circuitry 568, and/or other components and devices commonly found in a server or similar computing device. Those individual components of the payment server 506 may be similar to the corresponding components of the point of sale device 502, the description of which is applicable to the corresponding components of the payment server 506 and is not repeated herein so as not to obscure the present disclosure. Additionally, in some embodiments, the payment server 506 may be embodied as a “virtual server” formed from multiple computing devices distributed across the network 508 and operating in a public or private cloud. Accordingly, although the payment server 506 is illustrated in FIG. 1 as embodied as a single server computing device, it should be appreciated that the payment server 506 may be embodied as multiple devices cooperating together to facilitate the functionality described below.

As discussed in more detail below, the point of sale device 502, the wearable computing device 504, and the payment server 506 may be configured to transmit and receive data with each other and/or other devices of the system 500 over the network 508. The network 508 may be embodied as any number of various wired and/or wireless networks. For example, the network 508 may be embodied as, or otherwise include, a wired or wireless local area network (LAN), a wired or wireless wide area network (WAN), a cellular network, and/or a publicly-accessible, global network such as the Internet. As such, the network 508 may include any number of additional devices, such as additional computers, routers, and switches, to facilitate communications among the devices of the system 500.

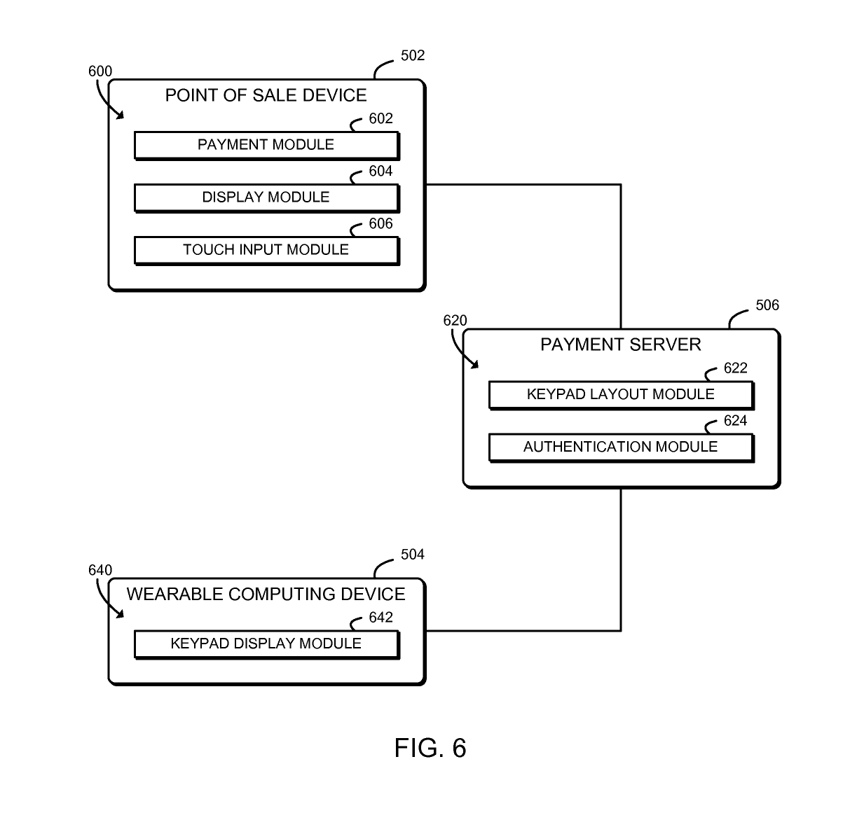

Referring now to FIG. 6, in an illustrative embodiment, the point of sale device 502 establishes an environment 600 during operation. The illustrative environment 600 includes a payment module 602, a display module 604, and a touch input module 606. The various modules of the environment 600 may be embodied as hardware, firmware, software, or a combination thereof. For example the various modules, logic, and other components of the environment 600 may form a portion of, or otherwise be established by, the processor 520 or other hardware components of the point of sale device 502.

The payment module 602 is configured to detect payment requests initiated by the user and request the payment server 506 to generate a virtual keypad layout in response to the payment requests. Payment requests may include any user action initiating a payment transaction, such as selecting a user interface command, swiping a payment card, or bringing a near-field communication payment device near the point of sale device 502. The payment module 602 is also configured to process the payment transaction in response to user input authentication, as further described below.

The display module 604 is configured to control the display 532. In particular, the display module 604 is configured to clear at least a part of the display 532 in response to detecting the payment request, and prior to the virtual keypad layout being displayed by the wearable computing device 504. The display module 604 may also display reference guides to assist the wearable computing device 504 in displaying the virtual keypad layout.

The touch input module 606 is configured to detect touch input using the touch screen 530 and transmit the touch input to the payment server 506. The touch input may be indicative of one or more user touch interactions, such as taps, swipes, presses, or other user interactions sensed by the touch screen 530. The touch input may include one or more coordinates (e.g., x- and y-coordinates) associated with each of the touch interactions. The coordinates may identify a location of the touch interaction on the touch screen 530 and, thus, may also be used by the payment server 506 to identify a location within the virtual keypad layout.

Still referring to FIG. 6, in the illustrative embodiment, the payment server 506 establishes an environment 620 during operation. The illustrative environment 620 includes a keypad layout module 622 and an authentication module 624. The various modules of the environment 620 may be embodied as hardware, firmware, software, or a combination thereof. For example the various modules, logic, and other components of the environment 620 may form a portion of, or otherwise be established by, the processor 560 or other hardware components of the payment server 506.

The keypad layout module 622 is configured to generate a random virtual keypad layout. In some embodiments, the keypad layout module 622 may also generate a one-time password associated with the virtual keypad layout. The virtual keypad includes several virtual buttons that may be selected by the user to enter a password or PIN. For example, the virtual keypad may include virtual buttons for any combination of letters, numbers, symbols, or control functions (e.g., backspace, return, etc.). The virtual keypad layout defines the location and/or ordering of the virtual buttons included in a virtual keypad. The virtual keypad layout may be randomized by randomly selecting the position of the virtual keypad, the position of the virtual buttons of the keypad, and/or the characters associated with each virtual button. The keypad layout module 622 is also configured to determine the keypad input entered by the user based on touch input received from the point of sale device 502. For example, the keypad layout module 622 may analyze coordinates of the touch input to identify the virtual keypad button associated with those coordinates and to determine the associated input character or control function. Because the keypad layout module 622 is established by the payment server 506, the virtual keypad layout and the keypad input may not be accessed by the point of sale device 502.

The authentication module 624 is configured to authorize the payment transaction based on the keypad input. The authentication module 624 may be configured to perform any payment transaction authentication, verification, or authorization operations. For example, the authentication module 624 may authenticate or otherwise verify a password or PIN entered by the user, and the authentication module 624 may authenticate or otherwise verify payment information such as account numbers and account balances.

Still referring to FIG. 6, in the illustrative embodiment, the wearable computing device 504 establishes an environment 640 during operation. The illustrative environment 640 includes a keypad display module 642. The various modules of the environment 640 may be embodied as hardware, firmware, software, or a combination thereof. For example the various modules, logic, and other components of the environment 640 may form a portion of, or otherwise be established by, the processor 540 or other hardware components of the wearable computing device 504.

The keypad display module 642 is configured to display the virtual keypad layout on the head-mounted display 550, superimposed over the display 532 of the point of sale device 502. To the user of the wearable computing device 504, the virtual keypad appears to be positioned on the display 532, and thus the user may interact with the touch screen 530 using the virtual keypad layout as a guide. Because the keypad display module 642 is established by the wearable computing device 504, the contents of the head-mounted display 550 may not be accessed by the point of sale device 502.

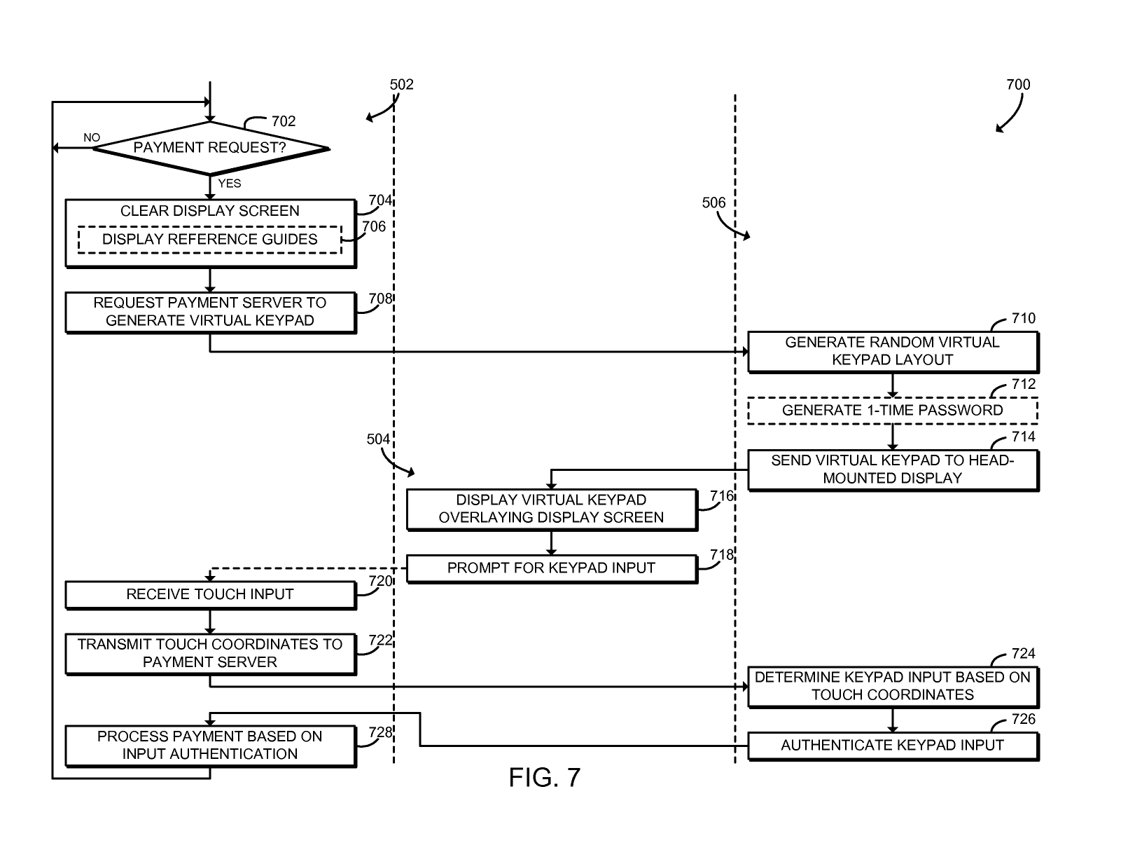

Referring now to FIG. 7, in use, the system 500 may execute a method 700 for secure user authentication. The method 700 begins with block 702, in which the point of sale device 502 determines whether a payment request has been received. A payment request may be initiated by a user of the point of sale device 502. For example, the user may swipe a payment card, place a near-field communication payment device near the point of sale device 502, or otherwise initiate a payment transaction. If no payment request has been received, the method 700 loops back to block 702 to continue monitoring for payment requests. If a payment request has been received, the method 700 advances to block 704.

In block 704, the point of sale device 502 clears a part of or all of the display 532. As described further below, the cleared part of the display 532 will be augmented by the wearable computing device 504 to display a virtual keypad layout. The point of sale device 502 may clear the display 532 by, for example, displaying a solid color such as white on part or all of the display 532. By displaying a solid color, malicious software may not gather any sensitive information from analysis of the frame buffer or other graphical data associated with the display 532. In some embodiments, the display 532 may display non-sensitive information on other parts of the display 532. For example, the display 532 may include instructions, a password prompt, user interface controls (e.g., OK or Cancel buttons), or other user interface features. In some embodiments, in block 706, the point of sale device 502 may display reference guides such as lines, boxes, crosshairs, or other marks on the display 532. The wearable computing device 504 may use the reference guides to aid in displaying the virtual keypad layout.

In block 708, the point of sale device 502 requests the payment server 506 to generate a virtual keypad for secure user authentication. The point of sale device 502 may use any appropriate technique to transmit the request to the payment server 506. For example, the point of sale device 502 may establish a secure network connection with the payment server 506 or use any other appropriate communication technique.

The method 700 continues with block 710, which is executed by the payment server 506. In block 710, the payment server 506 generates a random virtual keypad layout. The virtual keypad layout defines locations for virtual input buttons that will be used as a virtual keypad to collect user input. Each virtual input button may correspond with, for example, an input character such as a letter, number, symbol, or other character or may correspond with a control function such as backspace, escape, or return. The payment server 506 may use any technique to randomize the order, placement, and/or contents of the virtual input buttons. Because the virtual keypad layout is generated by payment server 506, the virtual keypad layout is not accessible by the point of sale device 502.

In block 712, in some embodiments, the payment server 506 generates a one-time password. The one-time password may be embodied as any string of random characters, including letters, numbers, symbols, or other characters. The one-time password may be unique to the current payment transaction and may not be re-used.

In block 714, the payment server 506 transmits the virtual keypad layout to the wearable computing device 504. The payment server 506 may use any appropriate technique to transmit the virtual keypad layout to the wearable computing device 504. For example, the payment server 506 may establish a network connection with the wearable computing device 504 or use any other appropriate communication technique. In some embodiments, the payment server 506 may send the one-time password to the wearable computing device 504 along with the virtual keypad layout.

The method 700 continues with block 716, which is executed by the wearable computing device 504. In block 716, the wearable computing device 504 displays the virtual keypad superimposed over the display 532 of the point of sale device 502, using the head-mounted display 550 of the wearable computing device 504. The wearable computing device 504 may display the keypad as, for example, a collection of virtual buttons or other input controls superimposed over the display 532. The wearable computing device 504 may analyze image data from the camera 552 to locate the display 532 of the point of sale device 502, for example by locating reference guides or other features displayed by the point of sale device 502. The wearable computing device 504 may resize and align the virtual keypad layout with the display 532 of the point of sale device 502 using the image data from the camera 552. Because the virtual keypad layout is actually displayed on the head-mounted display 550 by the wearable computing device 504, the graphical information associated with the virtual keypad layout is not accessible by the point of sale device 502.

In block 718, the wearable computing device 504 prompts the user for keypad input. The wearable computing device 504 may, for example, display a message instructing the user to enter a password or PIN on the touch screen 530 of the point of sale device 502. In some embodiments, the wearable computing device 504 may also display the one-time password and instruct the user to enter the one-time password.

The method 700 continues in block 720, which is executed by the point of sale device 502. In block 720, the point of sale device 502 receives touch input from the touch screen 530. The point of sale device 502 may receive touch input corresponding to one or more user touch interactions, such as taps, swipes, or other similar input events. The touch input may include one or more coordinates (e.g., x- and y-coordinates in pixels) identifying the location or locations of corresponding user touch interactions on the touch screen 530. As described above, those coordinates may correspond to parts of the display 532 that have been cleared or that otherwise do not provide any information concerning the target touched by the user.

In block 722, the point of sale device 502 transmits the touch input to the payment server 506. The point of sale device 502 may transmit any information that indicates the coordinates associated with the detected touch input. The point of sale device 502 may use any appropriate technique to communicate the information to the payment server 506. For example, the point of sale device 502 may establish a secure network connection with the payment server 506, or use any other appropriate communication technique.

The method 700 continues with block 724, which is executed by the payment server 506. In block 724, the payment server 506 determines keypad input based on the touch input received from the point of sale device 502. The keypad input may represent any character (e.g., a letter, number, or symbol) or command function corresponding to the virtual keypad button touched by the user. The payment server 506 may map the coordinates of the touch input to virtual buttons of the virtual keypad layout. The payment server 506 may, for example, read the coordinates associated with the touch input and identify the virtual keypad button corresponding with those coordinates. The keypad input may be stored as, for example, a character string representing the password, one-time password, and/or PIN entered by the user.

In block 726, the payment server 506 authenticates the keypad input. The payment server 506 may perform any user authentication, payment authentication, or other authentication process based on the keypad input entered by the user. For example, the payment server 506 may verify that the keypad input matches a user password, a PIN, or a one-time password previously generated by the payment server 506. The payment server 506 may also verify or authenticate payment information such as account number, account balance, or other payment information. The payment server 506 may transmit a message to the point of sale device 502 indicating whether the keypad input was successfully authenticated.

The method 700 continues with block 728, which is executed by the point of sale device 502. In block 728, the point of sale device 502 processes the payment request based on the input authorization. The point of sale device 502 may successfully complete the payment transaction if the keypad input was authenticated, reject the payment transaction if the keypad input was not authenticated, or perform any other appropriate action based on the input authentication. After processing the payment request, the method 700 loops back to block 702 to monitor for additional payment requests.

### EXAMPLES

Illustrative examples of the technologies disclosed herein are provided below. An embodiment of the technologies may include any one or more, and any combination of, the examples described below.

Example 1 includes a computing device for secure keypad input, the computing device comprising a first display screen coupled to a touch screen; a second display screen coupled to the first display screen, wherein the second display screen overlays at least a part of the first display screen; a security engine different from a host processor of the computing device; a keypad layout module established by the security engine of the computing device, the keypad layout module to generate a random virtual keypad layout, wherein the virtual keypad layout is not accessible by the host processor of the computing device; a keypad display module established by the security engine, the keypad display module to display the virtual keypad layout on the second display screen; and a touch input module to (i) determine, in response to a user selection of a virtual key of the virtual keypad layout, a touch input using the touch screen, wherein the touch input is indicative of a location of a touch interaction on the touch screen, and (ii) transmit the touch input to the security engine; wherein the keypad layout module is further to determine a keypad input as a function of the touch input and the virtual keypad layout, wherein the keypad input is indicative of the user selection from the virtual keypad layout; the computing device further comprising an authentication module established by the security engine, the authentication module to authorize a transaction as a function of the keypad input.

Example 2 includes the subject matter of Example 1, and further including a payment module to invoke the security engine to generate the virtual keypad layout; wherein to generate the random virtual keypad layout comprises to generate the random virtual keypad layout in response to invocation of the security engine.

Example 3 includes the subject matter of any of Examples 1 and 2, and wherein the payment module is further to detect a payment request initiated by a user; wherein to invoke the security engine comprises to invoke the security engine in response to detection of the payment request; and wherein to authorize the transaction comprises to authorize a payment transaction based on the payment request.

Example 4 includes the subject matter of any of Examples 1-3, and wherein to generate the random virtual keypad layout comprises to generate a random position on the second display screen for a virtual keypad button of the virtual keypad layout.

Example 5 includes the subject matter of any of Examples 1-4, and wherein the first display screen comprises a liquid crystal display screen and the second display screen comprises an electronic paper display screen.

Example 6 includes the subject matter of any of Examples 1-5, and wherein at least a part of the first display screen is visible through the second display screen.

Example 7 includes the subject matter of any of Examples 1-6, and further including a display module to clear at least a first part of the first display screen prior to the display of the virtual keypad layout; wherein to display the virtual keypad layout on the second display screen comprises to display the virtual keypad layout on a first part of the second display screen that overlays the first part of the first display screen.

Example 8 includes the subject matter of any of Examples 1-7, and wherein to determine the touch input comprises to determine coordinates on the touch screen associated with the touch interaction.

Example 9 includes the subject matter of any of Examples 1-8, and wherein to determine the keypad input comprises to determine a virtual keypad button of the virtual keypad layout that includes the coordinates associated with the touch input.

Example 10 includes the subject matter of any of Examples 1-9, and wherein to authorize the transaction as a function of the keypad input comprises to authenticate a password or a personal identification number represented by the keypad input.

Example 11 includes the subject matter of any of Examples 1-10, and wherein to authorize the transaction as a function of the keypad input comprises to encrypt the keypad input to generate an encrypted password or an encrypted personal identification number; and transmit the encrypted password or the encrypted personal identification number to an authentication server.

Example 12 includes the subject matter of any of Examples 1-11, and wherein the security engine comprises a manageability engine.

Example 13 includes the subject matter of any of Examples 1-12, and wherein the security engine comprises a trusted platform module.

Example 14 includes the subject matter of any of Examples 1-13, and wherein the keypad layout module is further to transmit a message from the security engine to the host processor in response to a determination of the keypad input; and the computing device further comprises a display module to display an indication of the keypad input on the first display screen in response to the message from the security engine.

Example 15 includes a method for secure keypad input, the method comprising generating, by a security engine of a computing device different from a host processor of the computing device, a random virtual keypad layout, wherein the virtual keypad layout is not accessible by the host processor of the computing device; displaying, by the security engine of the computing device, the virtual keypad layout on a second display screen of the computing device, wherein the second display screen is coupled to a first display screen of the computing device and the second display screen overlays at least a part of the first display screen; determining, by the computing device and in response to a user selection of a virtual key of the virtual keypad layout, a touch input using a touch screen of the computing device coupled to the first display screen, wherein the touch input is indicative of a location of a touch interaction on the touch screen; transmitting, by the computing device, the touch input to the security engine; determining, by the security engine of the computing device, a keypad input as a function of the touch input and the virtual keypad layout, wherein the keypad input is indicative of the user selection from the virtual keypad layout; and authorizing, by the security engine of the computing device, a transaction as a function of the keypad input.

Example 16 includes the subject matter of Example 15, and further including invoking, by the computing device, the security engine to generate the virtual keypad layout; wherein generating the random virtual keypad layout comprises generating the random virtual keypad layout in response to invoking the security engine.

Example 17 includes the subject matter of any of Examples 15 and 16, and further including detecting, by the computing device, a payment request initiated by a user; wherein invoking the security engine comprises invoking the security engine in response to detecting the payment request; and wherein authorizing the transaction comprises authenticating a payment transaction based on the payment request.

Example 18 includes the subject matter of any of Examples 15-17, and wherein generating the random virtual keypad layout comprises generating a random position on the second display screen for a virtual keypad button of the virtual keypad layout.

Example 19 includes the subject matter of any of Examples 15-18, and wherein the first display screen comprises a liquid crystal display screen and the second display screen comprises an electronic paper display screen.

Example 20 includes the subject matter of any of Examples 15-19, and wherein at least a part of the first display screen is visible through the second display screen.

Example 21 includes the subject matter of any of Examples 15-20, and further including clearing, by the computing device, at least a first part of the first display screen prior to displaying the virtual keypad layout; wherein displaying the virtual keypad layout on the second display screen comprises displaying the virtual keypad layout on a first part of the second display screen that overlays the first part of the first display screen.

Example 22 includes the subject matter of any of Examples 15-21, and wherein determining the touch input comprises determining coordinates on the touch screen associated with the touch interaction.

Example 23 includes the subject matter of any of Examples 15-22, and wherein determining the keypad input comprises determining a virtual keypad button of the virtual keypad layout that includes the coordinates associated with the touch input.

Example 24 includes the subject matter of any of Examples 15-23, and wherein authorizing the transaction as a function of the keypad input comprises authenticating a password or a personal identification number represented by the keypad input.

Example 25 includes the subject matter of any of Examples 15-24, and wherein authorizing the transaction as a function of the keypad input comprises encrypting the keypad input to generate an encrypted password or an encrypted personal identification number; and transmitting the encrypted password or the encrypted personal identification number to an authentication server.

Example 26 includes the subject matter of any of Examples 15-25, and wherein the security engine comprises a manageability engine.

Example 27 includes the subject matter of any of Examples 15-26, and wherein the security engine comprises a trusted platform module.

Example 28 includes the subject matter of any of Examples 15-27, and further including transmitting, by the security engine of the computing device, a message to the host processor in response to determining the keypad input; and displaying, by the computing device, an indication of the keypad input on the first display screen in response to the message from the security engine.

Example 29 includes a computing device comprising a processor; and a memory having stored therein a plurality of instructions that when executed by the processor cause the computing device to perform the method of any of Examples 15-28.

Example 30 includes one or more machine readable storage media comprising a plurality of instructions stored thereon that in response to being executed result in a computing device performing the method of any of Examples 15-28.

Example 31 includes a computing device comprising means for performing the method of any of Examples 15-28.

Example 32 includes a computing device for secure keypad input, the computing device comprising means for generating, by a security engine of the computing device different from a host processor of the computing device, a random virtual keypad layout, wherein the virtual keypad layout is not accessible by the host processor of the computing device; means for displaying, by the security engine of the computing device, the virtual keypad layout on a second display screen of the computing device, wherein the second display screen is coupled to a first display screen of the computing device and the second display screen overlays at least a part of the first display screen; means for determining, in response to a user selection of a virtual key of the virtual keypad layout, a touch input using a touch screen of the computing device coupled to the first display screen, wherein the touch input is indicative of a location of a touch interaction on the touch screen; means for transmitting the touch input to the security engine; means for determining, by the security engine of the computing device, a keypad input as a function of the touch input and the virtual keypad layout, wherein the keypad input is indicative of the user selection from the virtual keypad layout; and means for authorizing, by the security engine of the computing device, a transaction as a function of the keypad input.

Example 33 includes the subject matter of Example 32, and further including means for invoking the security engine to generate the virtual keypad layout; wherein the means for generating the random virtual keypad layout comprises means for generating the random virtual keypad layout in response to invoking the security engine.

Example 34 includes the subject matter of any of Examples 32 and 33, and further including means for detecting a payment request initiated by a user; wherein the means for invoking the security engine comprises means for invoking the security engine in response to detecting the payment request; and wherein the means for authorizing the transaction comprises means for authenticating a payment transaction based on the payment request.

Example 35 includes the subject matter of any of Examples 32-34, and wherein the means for generating the random virtual keypad layout comprises means for generating a random position on the second display screen for a virtual keypad button of the virtual keypad layout.

Example 36 includes the subject matter of any of Examples 32-35, and wherein the first display screen comprises a liquid crystal display screen and the second display screen comprises an electronic paper display screen.

Example 37 includes the subject matter of any of Examples 32-36, and wherein at least a part of the first display screen is visible through the second display screen.

Example 38 includes the subject matter of any of Examples 32-37, and further including means for clearing at least a first part of the first display screen prior to displaying the virtual keypad layout; wherein the means for displaying the virtual keypad layout on the second display screen comprises means for displaying the virtual keypad layout on a first part of the second display screen that overlays the first part of the first display screen.

Example 39 includes the subject matter of any of Examples 32-38, and wherein the means for determining the touch input comprises means for determining coordinates on the touch screen associated with the touch interaction.

Example 40 includes the subject matter of any of Examples 32-39, and wherein the means for determining the keypad input comprises means for determining a virtual keypad button of the virtual keypad layout that includes the coordinates associated with the touch input.

Example 41 includes the subject matter of any of Examples 32-40, and wherein the means for authorizing the transaction as a function of the keypad input comprises means for authenticating a password or a personal identification number represented by the keypad input.

Example 42 includes the subject matter of any of Examples 32-41, and wherein the means for authorizing the transaction as a function of the keypad input comprises means for encrypting the keypad input to generate an encrypted password or an encrypted personal identification number; and means for transmitting the encrypted password or the encrypted personal identification number to an authentication server.

Example 43 includes the subject matter of any of Examples 32-42, and wherein the security engine comprises a manageability engine.

Example 44 includes the subject matter of any of Examples 32-43, and wherein the security engine comprises a trusted platform module.

Example 45 includes the subject matter of any of Examples 32-44, and further including means for transmitting, by the security engine of the computing device, a message to the host processor in response to determining the keypad input; and means for displaying an indication of the keypad input on the first display screen in response to the message from the security engine.

1. A computing device for secure keypad input, the computing device comprising:
a first display screen coupled to a touch screen;
a second display screen coupled to the first display screen, wherein the second display screen overlays at least a part of the first display screen;
a security engine different from a host processor of the computing device;
a keypad layout module established by the security engine of the computing device, the keypad layout module to generate a random virtual keypad layout, wherein the virtual keypad layout is not accessible by the host processor of the computing device;
a keypad display module established by the security engine, the keypad display module to display the virtual keypad layout on the second display screen; and
a touch input module to (i) determine, in response to a user selection of a virtual key of the virtual keypad layout, a touch input using the touch screen, wherein the touch input is indicative of a location of a touch interaction on the touch screen, and (ii) transmit the touch input to the security engine;
wherein the keypad layout module is further to determine a keypad input as a function of the touch input and the virtual keypad layout, wherein the keypad input is indicative of the user selection from the virtual keypad layout;
the computing device further comprising an authentication module established by the security engine, the authentication module to authorize a transaction as a function of the keypad input.

2. The computing device of claim 1, further comprising a payment module to (i) detect a payment request initiated by a user and (ii) invoke the security engine to generate the virtual keypad layout in response to detection of the payment request;
wherein to generate the random virtual keypad layout comprises to generate the random virtual keypad layout in response to invocation of the security engine; and
wherein to authorize the transaction comprises to authorize a payment transaction based on the payment request.

3. The computing device of claim 1, wherein to generate the random virtual keypad layout comprises to generate a random position on the second display screen for a virtual keypad button of the virtual keypad layout.

4. The computing device of claim 1, wherein the first display screen comprises a liquid crystal display screen and the second display screen comprises an electronic paper display screen.

5. The computing device of claim 1, wherein at least a part of the first display screen is visible through the second display screen.

6. The computing device of claim 1, further comprising a display module to clear at least a first part of the first display screen prior to the display of the virtual keypad layout;
wherein to display the virtual keypad layout on the second display screen comprises to display the virtual keypad layout on a first part of the second display screen that overlays the first part of the first display screen.

7. The computing device of claim 1, wherein:
to determine the touch input comprises to determine coordinates on the touch screen associated with the touch interaction; and
to determine the keypad input comprises to determine a virtual keypad button of the virtual keypad layout that includes the coordinates associated with the touch input.

8. The computing device of claim 1, wherein to authorize the transaction as a function of the keypad input comprises to:
encrypt the keypad input to generate an encrypted password; and
transmit the encrypted password to an authentication server.

9. The computing device of claim 1, wherein the security engine comprises a manageability engine.

10. The computing device of claim 1, wherein the security engine comprises a trusted platform module.

11. The computing device of claim 1, wherein:
the keypad layout module is further to transmit a message from the security engine to the host processor in response to a determination of the keypad input; and
the computing device further comprises a display module to display an indication of the keypad input on the first display screen in response to the message from the security engine.

12. A method for secure keypad input, the method comprising:
generating, by a security engine of a computing device different from a host processor of the computing device, a random virtual keypad layout, wherein the virtual keypad layout is not accessible by the host processor of the computing device;
displaying, by the security engine of the computing device, the virtual keypad layout on a second display screen of the computing device, wherein the second display screen is coupled to a first display screen of the computing device and the second display screen overlays at least a part of the first display screen;
determining, by the computing device and in response to a user selection of a virtual key of the virtual keypad layout, a touch input using a touch screen of the computing device coupled to the first display screen, wherein the touch input is indicative of a location of a touch interaction on the touch screen;
transmitting, by the computing device, the touch input to the security engine;
determining, by the security engine of the computing device, a keypad input as a function of the touch input and the virtual keypad layout, wherein the keypad input is indicative of the user selection from the virtual keypad layout; and
authorizing, by the security engine of the computing device, a transaction as a function of the keypad input.

13. The method of claim 12, wherein at least a part of the first display screen is visible through the second display screen.

14. The method of claim 12, further comprising clearing, by the computing device, at least a first part of the first display screen prior to displaying the virtual keypad layout;
wherein displaying the virtual keypad layout on the second display screen comprises displaying the virtual keypad layout on a first part of the second display screen that overlays the first part of the first display screen.

15. The method of claim 12, wherein authorizing the transaction as a function of the keypad input comprises:
encrypting the keypad input to generate an encrypted password; and
transmitting the encrypted password to an authentication server.

16. The method of claim 12, further comprising:
transmitting, by the security engine of the computing device, a message to the host processor in response to determining the keypad input; and
displaying, by the computing device, an indication of the keypad input on the first display screen in response to the message from the security engine.

17. One or more computer-readable storage media comprising a plurality of instructions that in response to being executed cause a computing device to:
generate, by a security engine of the computing device different from a host processor of the computing device, a random virtual keypad layout, wherein the virtual keypad layout is not accessible by the host processor of the computing device;
display, by the security engine, the virtual keypad layout on a second display screen of the computing device, wherein the second display screen is coupled to a first display screen of the computing device and the second display screen overlays at least a part of the first display screen;
determine, in response to a user selection of a virtual key of the virtual keypad layout, a touch input using a touch screen of the computing device coupled to the first display screen, wherein the touch input is indicative of a location of a touch interaction on the touch screen;
transmit the touch input to the security engine;
determine, by the security engine, a keypad input as a function of the touch input and the virtual keypad layout, wherein the keypad input is indicative of the user selection from the virtual keypad layout; and
authorize, by the security engine, a transaction as a function of the keypad input.

18. The one or more computer-readable storage media of claim 17, wherein at least a part of the first display screen is visible through the second display screen.

19. The one or more computer-readable storage media of claim 17, further comprising a plurality of instructions that in response to being executed cause the computing device to clear at least a first part of the first display screen prior to displaying the virtual keypad layout;
wherein to display the virtual keypad layout on the second display screen comprises to display the virtual keypad layout on a first part of the second display screen that overlays the first part of the first display screen.

20. The one or more computer-readable storage media of claim 17, wherein to authorize the transaction as a function of the keypad input comprises to:
encrypt the keypad input to generate an encrypted password; and
transmit the encrypted password to an authentication server.

21. The one or more computer-readable storage media of claim 17, further comprising a plurality of instructions that in response to being executed cause the computing device to:
transmit, by the security engine, a message to the host processor in response to determining the keypad input; and
display an indication of the keypad input on the first display screen in response to the message from the security engine.
